(19) United States
(12) Patent Application Publication
(10) Pub. No.: US 2011/0273388 A1
(43) Pub. Date: Nov. 10, 2011

(54) APPARATUS AND METHOD FOR RECEIVING GESTURE-BASED INPUT IN A MOBILE DEVICE

(75) Inventors: Jong Sung JOO, Seoul (KR); Il Geun BOK, Seoul (KR); Myoung Hwan HAN, Seoul (KR); Tae Yeon KIM, Seoul (KR)

(73) Assignee: SAMSUNG ELECTRONICS CO., LTD., Gyeonggi-Do (KR)

(21) Appl. No.: 13/103,177

(22) Filed: May 9, 2011

(30) Foreign Application Priority Data
May 10, 2010 (KR) 10-2010-0043426

(51) Int. Cl. G06F 3/041; G06F 3/033

(52) U.S. Cl. 345/173; 715/863

(57) ABSTRACT

A method for receiving a user's gesture-based input and apparatus of a mobile device is provided. The method and apparatus halts an input function by a particular mode that is executed when a present event occurs on the mobile device, creates a new input area, allows for a user's gesture-based input, and controls the function of the mobile device according to the user's gesture. The method includes: sensing an event that occurs while the mobile device is operating in a particular mode; and creating a new input area for receiving a user's gesture-based input and providing it. When the event occurs, the input function with respect to data of the particular mode is halted. The new input area is provided as a fog screen having a fog effect. The functions of the mobile device are controlled according to a user's gestures that are performed on the fog screen.

### CLAIM OF PRIORITY

This application claims the benefit under 35 U.S.C. §119 of a Korean Patent Application filed in the Korean Intellectual Property Office on May 10, 2010 and assigned Serial No. 10-2010-0043426, the entire disclosure of which is hereby incorporated by reference.

### BACKGROUND OF THE INVENTION

1. Field of the Invention

This invention relates to an electronic communication system. More particularly, the invention relates to a method for receiving gesture-based input that can halt an input mode, according to data having been displayed, and launch a gesture mode, when a mobile device receives an input, and can support a user's gesture-based input. The invention also relates to an apparatus for receiving gesture-based input in a mobile device.

2. Description of the Related Art

With the rapid development of information and communication technology and semiconductor technology, the use of various types of mobile devices has also increased. Mobile devices utilize mobile convergence to provide additional functions provided by other types of mobile systems, as well as their traditional functions. For example, mobile communication devices have additional functions as well as their traditional communication functions such as a voice call, and message transmission and reception. Examples of additional functions are a TV viewing function (e.g., mobile broadcasting, such as Digital Multimedia Broadcasting (DMB), Digital Video Broadcasting (DVB), etc.), an audio playback function (e.g., MPEG Audio Layer 3 (MP3)), a photographing function, an Internet access function, a dictionary search function, etc.

In order to provide the functions listed above, conventional mobile devices are introducing new types of hardware and software. One example is an attempt to improve a user interface environment so that a user can easily use the functions of a mobile device. In addition, conventional mobile devices are also being improved to enhance the use convenience and to include new functions.

### SUMMARY OF THE INVENTION

The invention has been made in view of the above problems, and proposes a technology that provides a new additional function to a mobile device.

The invention further provides a technology to a layer that can receive a touch command on a conventional screen when an input is newly created and can implement a user interface environment where a function can be executed according to an input that is received by the layer.

The invention further provides a method for receiving a user's gesture-based input in a mobile device that can execute an input halt mode, according to data having been displayed, and a gesture mode, when an input is created, can provide a new input area on a fog screen having a fog effect when the gesture mode is executed, and can allow a user's gesture based input to be input to the new input area.

The invention further provides a mobile device adapted to the method for receiving a user's gesture-based input.

The invention further provides a technology to enhance user convenience of a mobile device by providing a new input area having a fog effect to a given executed screen, which can be intuitively recognized by a user, and by implementing various additional functions on the new input area, according to user's gestures.

In accordance with an exemplary embodiment of the invention, the invention provides a method for receiving a user's gesture-based input in a mobile device including: sensing an event that occurs on the mobile device while the mobile device is operating in a particular mode; and creating a new input area for receiving the user's gesture-based input and displaying the input area on a display of the mobile device.

In accordance with another exemplary embodiment of the invention, the invention provides a method for receiving a user's gesture-based input in a mobile device including: sensing an event that occurs on the mobile device while the mobile device is operating in a particular mode; halting a currently executing input function with respect to displayed data of the particular mode; operating a gesture mode and displaying a fog screen having a fog effect; receiving a user's gesture via the fog screen; and controlling a function corresponding to the user's input gesture.

Preferably, the method for receiving a user's gesture-based input may be implemented with programs that can execute the processes, which are stored in a computer-readable recording media.

In accordance with another exemplary embodiment of the invention, the invention provides a mobile device for receiving a user's gesture-based input in including: an event input unit for receiving an event to launch a gesture mode; a display unit for displaying, when the gesture mode is executed, a fog screen having a fog effect, and for displaying an object corresponding to a gesture input to the fog screen in a transparent or translucent mode; and a controller for controlling, when the event input unit senses an event, the displaying of the fog screen according to the execution of the gesture mode, and controlling a function of the mobile device according to the user's gesture-based input performed on the fog screen.

### BRIEF DESCRIPTION OF THE DRAWINGS

The features and advantages of the invention will become more apparent from the following detailed description in conjunction with the accompanying drawings, in which:

FIG. 1 illustrates a schematic block diagram of a mobile device according to an embodiment of the invention;

FIG. 2 illustrates screens when a gesture launch mode is executed in a mobile device, according to an embodiment of the invention;

FIGS. 3 to 7 illustrate screens when a gesture launch mode is operated in a mobile device, according to an embodiment of the invention;

FIG. 8 illustrates a flow chart that describes a function providing method of a mobile device, according to an embodiment of the invention; and

FIGS. 9A and 9B illustrate a flow that describes a method for controlling the execution of a particular function, using input area created by an event occurred in a mobile device, according to an embodiment of the invention.

### DETAILED DESCRIPTION OF THE INVENTION

Hereinafter, exemplary embodiments of the invention are described in detail with reference to the accompanying drawings. The same reference numbers are used throughout the drawings to refer to the same or similar parts. For the purposes of clarity and simplicity, detailed descriptions of well-known functions and structures incorporated herein may be omitted to avoid obscuring the subject matter of the invention.

This invention is related to a method and apparatus that can provide a new input area and can accordingly support a user's input via the input area. The mobile device according to an embodiment of the invention halts an input operation with respect to given data displayed on the display unit and provides a gesture launch mode, when an input is created. In particular, in this embodiment the mobile device provides a new input area displayed as a fog screen/fog window corresponding to a fog effect during the gesture launch mode. In addition, the invention supports a user's gesture-based input via an input area by a fog effect, and also executes an application according to the user's gesture input. That is, when a preset input is created, the mobile device and the method for controlling the mobile device, according to the invention, can create a new layer that can receive a touch command via a given displayed screen and can also execute a function corresponding to an input value input to a corresponding layer.

In an embodiment of the invention, the term ‘fog effect’ refers to an effect that shows on a screen where the screen of the display unit is clouded with fog, which is called a fog screen, similar to when a user blows on a glass window. The fog effect according to the invention can be shown by halting a currently executing input process of given data displayed on the display unit and by using a new input area (layer) overlaid on the given data. In an embodiment of the invention, a screen where a fog effect is applied to a new input area is called a fog screen. The user can input a gesture via a fog screen. In the following description, a mode where a fog screen with a fog effect is created and allows a user to input his/her gestures via the fog screen is called a gesture launch mode. The following embodiment of the invention implements the fog screen in a translucent form according to the fog effect. However, it should be understood that the invention is not limited to this embodiment. For example, the fog screen may appear as a transparent form when being implemented without a fog effect. That is, a fog effect is designed to allow a user to intuitively and sensibly recognize that he/she can input a gesture in a gesture launch mode.

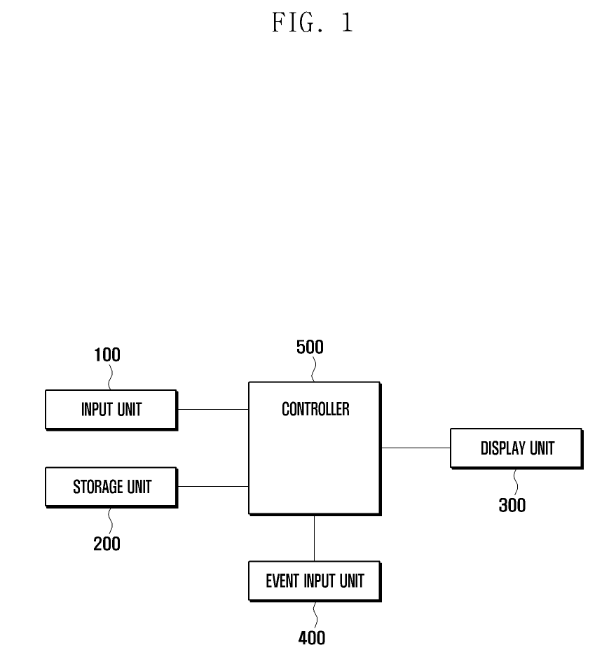

In the following description, a mobile device and a method for controlling the operations thereof are explained in detail referring to FIG. 1 to FIGS. 9A and 9B. It should be understood that the invention is not limited to the following embodiments. It will be noted that there may be many modifications from the embodiments.

FIG. 1 illustrates a schematic block diagram of a mobile device according to an embodiment of the invention.

Referring to FIG. 1, the mobile device includes an input unit 100, a storage unit 200, a display unit 300, an event input unit 400, and a controller 500.

It should be understood that the mobile device may further include the following components according its functions: a radio frequency (RF) communication unit for performing wireless communication; an audio processing unit with a microphone and a speaker; a digital broadcasting module for receiving and reproducing digital broadcasts (e.g., mobile broadcasts such as digital multimedia broadcasting (DMB), digital video broadcasting (DVB), etc.); a camera module for photographing pictures/motion pictures; a Bluetooth communication module for performing Bluetooth communication, an Internet communication module for performing an Internet communication function; a touchpad for receiving a touch-based input; etc. In this application, a detailed description of these components is omitted.

The input unit 100 senses a user's operations, creates input signals corresponding thereto, and transfers them to the controller 500. The input unit 100 may be configured to include a number of buttons. The input unit 100 also includes at least one or more buttons that create input signals according to the execution of a gesture launch mode (or a fog effect).

The storage unit 200 stores application programs related to the mobile device and data processed in the mobile device. The storage unit 200 may be implemented with at least one or more volatile memory devices and non-volatile memory devices. For example, the storage unit 200 can permanently or temporarily store an operation system of the mobile device, data and programs related to the display control operations of the display unit 300, data and programs related to the input control operations using the display unit 300, data and programs related to the execution and the operations of a gesture launch mode, data and programs related to the execution and the operations of a fog effect, data and programs related to the execution and operations of an application according to a gesture input in the gesture launch mode, etc. The storage unit 200 is comprised of a storage area for storing a table that maps information regarding gestures with function information, where the gestures are performed in an input area created in the gesture launch mode. An example of the mapping table is shown in the following table 1.

TABLE 1

| Gesture | |
|---|---|
| Information | Function Information |
| 8 | Dial a phone number mapped to shortcut No. Key 8 |
| D | Execute dialing mode |
| M | Execute message writhing mode |
| @ | Execute email writing mode |
| [symbol] | Execute favorite function |
| . . . | . . . |

As shown in table 1, gesture information may be defined as 8, D, M, @, [symbol] , etc. The gesture information may be defined according to a user's settings or provided as a default setting in the mobile device. The gesture information may be mapped to executable corresponding function information. For example, when the user inputs a gesture in a form of a number ‘8,’ the mobile device extracts gesture information regarding the number ‘8’ corresponding to the number 8 and then function information according to the extracted gesture information. After that, the mobile device performs a shortcut dialing function according to a phone number mapped to the shortcut number 8.

The display unit 300 provides screens according to the execution of applications of the mobile device. The applications refer to programs for executing a variety of functions, such as message, email, Internet function, multimedia function, search, communication, electronic book (e-book) function, motion picture function, picture/motion picture viewing and photographing functions, TV viewing function (e.g., mobile broadcasts, such as DMB, DVB, etc.), audio file playback (e.g., MP3), widget function, scribbling function, note function, fog function, etc. The display unit 300 may be implemented with a Liquid Crystal Display (LCD), an Organic Light Emitting Diode (OLED), an Active Matrix Organic Light Emitting Diodes (AMOLED), or the like. The display unit 300 may display screen data in a landscape or portrait mode.

The display unit 300 may be implemented with a touch input unit (not shown), for example, a touch screen. In that case, the display unit 300 of a touch screen allows a user to perform touch-based gestures, creates the input signals (i.e., touch signals) according thereto, and transfers them to the controller 500. The display unit 300 also displays screens according to a fog effect (i.e., a fog screen). In another embodiment of the invention, a visual effect, such as a fog effect, may not appear according to the types of executions of a gesture launch mode (e.g., transparent or translucent). The display unit 300 may also display the form of a user gesture input onto a fog screen according to a fog effect. The method for controlling screens according to a fog effect will be described later. In this description of the invention, for the sake of convenient description, the fog effect, the gesture launch mode, and the fog screen are differentiated.

The event input unit 400 senses a user's input, creates signals corresponding thereto, and transfers them to the controller 500. The event input unit 400 can halt an input function with respect to data displayed on the display unit 300, and create an input signal for requesting the creation of a new input area (e.g., a fog screen with a fog effect). That is, the event input unit 400 can receive an input signal for executing a gesture launch mode.

The event input unit 400 may be implemented with a microphone, a wind sensor, a pressure sensor, a motion sensor, an illumination sensor, a proximity sensor, etc. It should be understood that the event input unit 400 may be implemented with any type of sensor that allows a user's input to create a new input area in a gesture launch mode. In another embodiment of the invention, the event input unit 400 is a microphone or a wind sensor to sense a user' blowing on the device. However, it should be understood that the invention is not limited to the embodiment. For example, the event input unit 400 is implemented with a pressure sensor. When the pressure sensor senses a pressure signal of a magnitude that is equal to or greater than a preset value, it can create a new input area during the gesture launch mode. In addition, the event input unit 400 is implemented with a motion sensor. In that case, when the motion sensor senses a motion signal corresponding to a preset motion, a new input area can be repeated during the gesture launch mode. Likewise, the event input unit 400 is also implemented with an illumination sensor (or proximity sensor). In that case, when the illumination sensor (or proximity sensor) senses a proximity signal according to the access of an object (e.g., a user's hand), a new input area can be created during the gesture launch mode.

The controller 500 controls the entire operation of the mobile device. The controller 500 can control functions according to the operation of a gesture launch mode. For example, the controller 500 can halt an input operation with respect to data of the display unit 300 when an event is detected by the event input unit 400. The controller 500 can create a new input area (layer) according to a gesture launch mode and awaits a gesture-based input. The controller 500 can provide the new input area in a transparent or translucent form, according to the settings, when executing the gesture launch mode. In particular, when the controller 500 provides a new input area in the translucent form, it can control the display operation of a fog screen with a fog effect. After that, the controller 500 senses a user's gesture-based input via the new input area, and accordingly provides a function corresponding to the input. This control operation will be described in detail later.

In addition, the controller 500 controls the entire function of the mobile device. For example, the controller 500 controls the displaying and processing of data when an application is executed. The controller 500 controls the switching from a current mode to a gesture launch mode. The controller 500 controls the operations related to the event input unit 400. For example, when the event input unit 400 is a microphone and the mobile device is operated in a call mode or a voice recording mode, the controller 500 ignores the event that occurred on the event input unit 400 but controls the common operations such as a voice input operation.

As shown in FIG. 1, the invention can be applied to all types of mobile devices, for example, a bar type, a folder type, a slide type, a swing type, a flip-flop type, etc. The mobile device according to the invention includes all information communication devices, multimedia devices, and their applications, which are operated according to communication protocols corresponding to a variety of communication systems. For example, the mobile device can be applied to mobile communication terminals, Portable Multimedia Players (PMPs), digital broadcast players, Personal Digital Assistants (PDAs), audio players (e.g., MP3 players), mobile game players, smart phones, etc.

In addition, the method for displaying screens according to a fog effect and the function providing method using a fog effect, according to the invention, can be adapted to televisions, Large Format Displays (LFDs), Digital Signages (DSs), media poles, personal computers, laptop computers, etc.

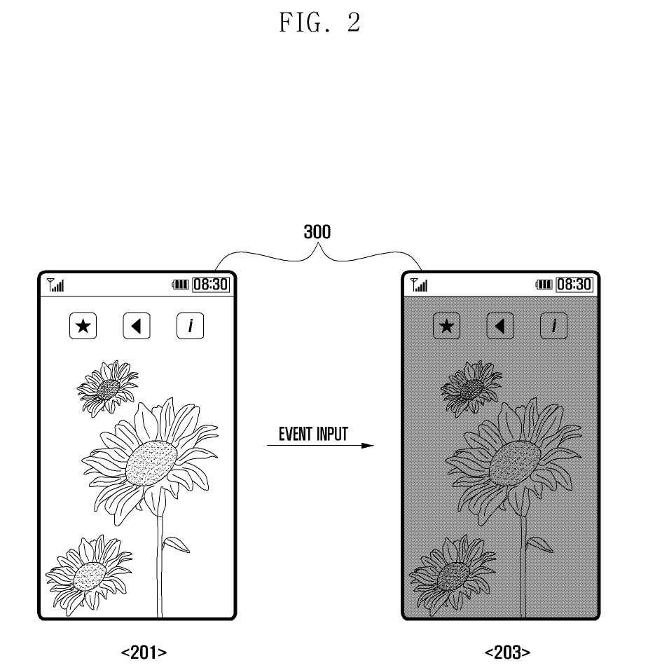

FIG. 2 illustrates screens when a gesture launch mode is executed in a mobile device, according to an embodiment of the invention.

FIG. 2 shows the alteration from a screen displaying screen data to another screen having a fog effect, i.e., a fog screen, when an event for executing a gesture launch mode occurs. In an embodiment of the invention, the event for executing a gesture launch mode can occur on an idle screen in an idle mode, a screen in an application mode according to the execution of a particular application, or a screen in an off mode when the display unit 300 is turned off. This will be described in detail later.

As shown in diagram 201 of FIG. 2, the display unit 300 outputs screen data, i.e., displays a particular screen image. When an event occurs on the event input unit 400 while outputting screen data on the display unit 300, the mobile device launches a gesture mode. When operating in the gesture mode, a translucent layer (input area) with a fog effect is provided on the layer showing the previously displayed screen data as shown in diagram 203.

In a state where the screen data is displayed as shown in diagram 201, the mobile device may execute a gesture launch mode in various methods according to the type of event input unit 400: in a case where, when the event input unit 400 is a microphone (or wind sensor), it senses blowing of a magnitude equal to or greater than a preset value; in a case where, when the event input unit 400 is a pressure sensor, it senses pressure equal to or greater than a preset value; in a case where, when the event input unit 400 is a motion sensor, it senses a preset motion; and in a case where, when the event input unit 400 is a illumination sensor (or proximity sensor), it senses the approach of a particular object.

When the gesture launch mode is executed, a translucent layer formed by a fog effect (e.g., a fog screen) is created and displayed on the display unit 300 as shown in diagram 203. In that case, the given layer under the fog screen is displayed dimly by the fog effect, so that the screen data displayed on the given layer is also displayed dimly. The given screen data may disappear or completely appear on the layer according to the setting of fog transparency (fog screen). In an embodiment of the invention, the inputting of given data is ignored in the gesture launch mode.

As shown in diagram 203, the fog effect may appear in various forms according to the settings or the types of event input unit 400. For example, when the event input unit 400 is a microphone (or wind sensor), a fog effect starts appearing from a position where the microphone (or wind sensor) is located (e.g., the bottom of the mobile device), and then gradually spreads until it covers the entire area of the display unit 300. Alternatively, a fog effect starts appearing from the center portion of the display unit 300 and then gradually spreads until it covers the entire area of the display unit 300. In addition, when the event input unit 400 is a pressure sensor, a fog effect starts appearing from an area where pressure occurs, and then gradually spreads until it covers the entire area of the display unit 300.

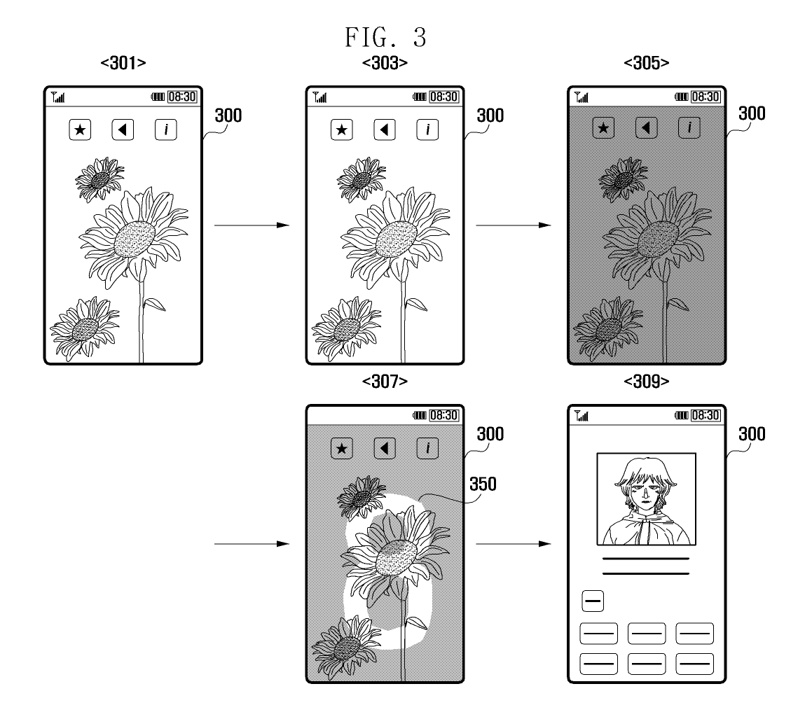

FIG. 3 illustrates an example of screens when a gesture launch mode is operated in a mobile device, according to an embodiment of the invention. The screens are displayed when a shortcut dialing function is executed by using an input area created by a fog effect.

As shown in diagram 301 of FIG. 3, it is assumed that the mobile device is operated in an idle mode and accordingly the display unit 300 displays an idle screen. It is also assumed that the event input unit 400 is a microphone or wind sensor and a gesture launch mode is executed when a user blows into a microphone or wind sensor.

A gesture launch mode can be executed in a state where an idle screen is displayed on the display unit 300 as shown in diagram 301. For example, an event for executing a gesture launch mode, such as a user blowing onto the device, may occur at the microphone or wind sensor as shown in diagram 303.

When such an event has occurred, a new layer appears on the display unit 300 as shown in diagram 305. In an embodiment of the invention, the new layer may be a translucent layer form having a fog effect so that the user can intuitively or sensibly recognize it. The transparency of the layer is adjustable according to the transparency settings. In an embodiment of the invention, the display unit 300 may provide only a transparent layer form that can allow for the input of a user's gesture-based touch command without a fog effect when the gesture launch mode is executed.

A user's gesture-based input can be applied to the new layer having a fog effect (e.g., a fog screen) in a state where the screen is displayed as shown in diagram 305. For example, a particular gesture (e.g., corresponding to the shape of number ‘8’) may be performed on the fog screen as shown in diagram 307. In that case, as shown in diagram 309, an application corresponding to the particular gesture (e.g., corresponding to the shape of number ‘8’) is executed and a corresponding screen appears. That is, when the user performs a gesture on the fog screen in the gesture launch mode, it is detected and an application corresponding to the detected gesture is executed and a screen corresponding to the execution of the application is displayed on the display unit 300.

In the embodiment illustrated in FIG. 3, it is assumed that, when the user makes the shape of number ‘8’ on the display unit 300, shortcut dialing to the phone number mapped to shortcut number ‘8’ is automatically performed and a corresponding screen appears. In that case, the displaying of the fog screen according to a fog event, as shown in diagram 309, may be omitted. That is, the gesture launch mode may be automatically terminated. Automatic termination of such a gesture launch mode may be set according to a user's settings. For example, a gesture launch mode may be terminated when an application is executed according to the input of a user's gesture. Alternatively, a gesture launch mode is operated as a background mode when an application is executed, so that the function of the application is executed, and then the gesture launch mode is re-activated when the application is terminated.

Although the embodiment describes a user's gesture corresponding to the shape of the number ‘8’ as shown in diagram 307 of FIG. 3, it should be understood that the object 350 according to a user's gesture (corresponding to the shape of the number ‘8’) can be displayed in various forms. For example, the object 350 according to a user's gesture (corresponding to the shape of the number ‘8’) may be displayed in a paint mode or a transparent mode. The paint mode refers to a mode where the fog screen is painted as the object 350 (e.g., the shape of the number ‘8’) when it is drawn according to the movement direction of the user's gesture. The transparent mode refers to a mode where the object 350 (e.g., the shape of the number ‘8’) is removed from the fog screen according to the movement direction of the user's gesture and a corresponding transparent portion appears. In particular, in the transparent mode, the transparent portion of the object 350 (e.g., the shape of the number ‘8’) allows the previously displayed data on the lower layer to be clearly displayed therethrough. The embodiment of the invention, as shown in diagram 307, is implemented with the transparent mode where a realistic element is shown on the display unit so that the user can easily and intuitively recognize it. For example, the transparent mode is operated as the breath clouding a glass window is removed according to a user's gesture so that the glass window is cleared.

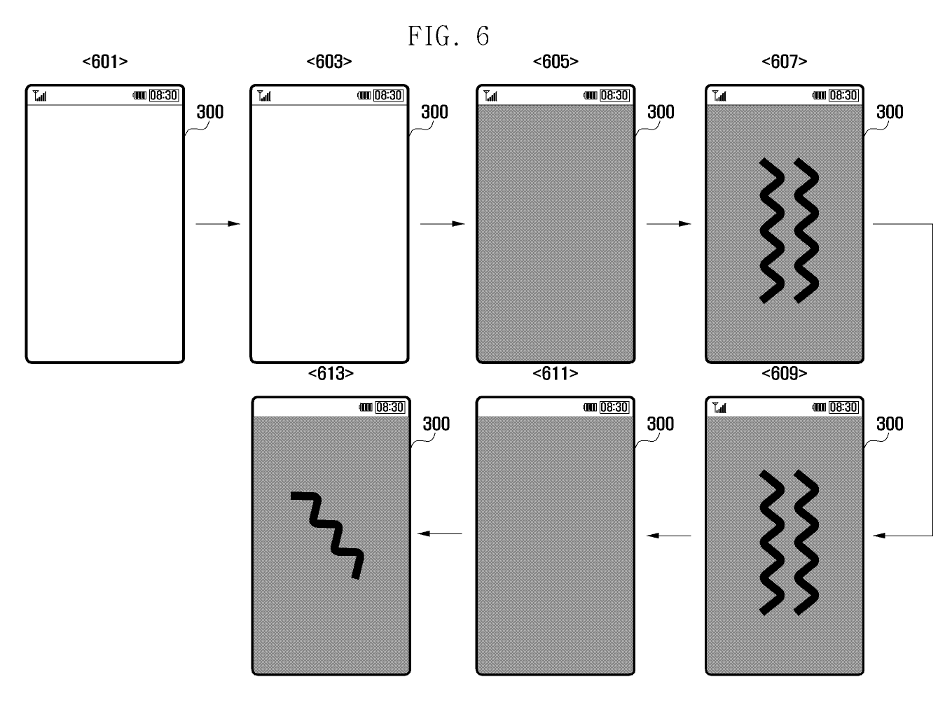

Although the embodiment of FIG. 3 is not described in detail, if no function is mapped to an input gesture, the process of application execution may be omitted. In addition, according to the settings, the embodiment may be implemented in such a manner that an error message may be output to state that there is no application corresponding to a gesture. Alternatively, the embodiment may also be implemented in such a manner that, according to the settings, a fog screen is initialized by inputting another event and then another gesture is input, which will be described later referring to FIG. 6. In addition, the embodiment may also be implemented in such a manner that, according to the settings, an error message is output, a fog screen is automatically initialized, and it awaits the input of another gesture.

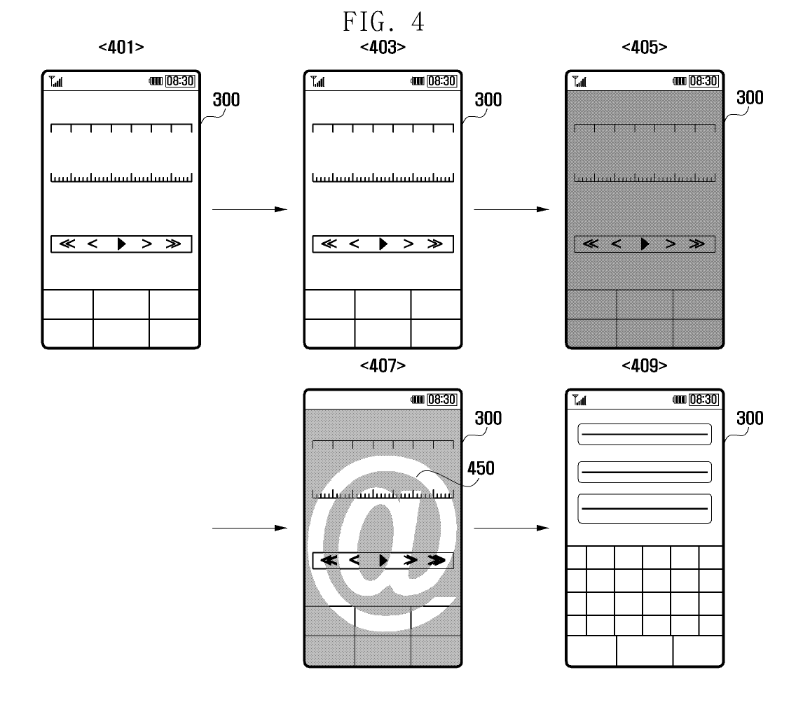

FIG. 4 illustrates another example of screens when a gesture launch mode is operated in a mobile device, according to an embodiment of the invention. The screens are displayed when an email writing function is executed by using an input area created by a fog effect.

As shown in diagram 401 of FIG. 4, it is assumed that the mobile device operates a particular application (e.g., a radio broadcasting function) and accordingly the display unit 300 displays a screen (e.g., a playback screen of a radio broadcast). It is also assumed that the event input unit 400 is a microphone or wind sensor and a gesture launch mode is executed when a user blows into the microphone or wind sensor.

A gesture launch mode can be executed in a state where the playback screen is displayed on the display unit 300 as shown in diagram 401. For example, an event for executing a gesture launch mode, such as blowing, may occur at the microphone or wind sensor as shown in diagram 403.

When such an event has occurred, a new layer appears on the display unit 300 as shown in diagram 405. In an embodiment of the invention, the new layer may be a translucent layer form having a fog effect so that the user can intuitively or sensibly recognize it. The transparency of the layer is adjustable according to the transparency settings. In an embodiment of the invention, the display unit 300 may provide only a transparent layer form that can allow for the input of a user's gesture-based touch command without a fog effect when the gesture launch mode is executed.

A user's gesture-based input can be applied to the new layer having a fog effect (e.g., a fog screen) in a state where the screen is displayed as shown in diagram 405. For example, a particular gesture (e.g., corresponding to the shape of symbol ‘@’) may be performed on the fog screen as shown in diagram 407. In that case, as shown in diagram 409, an application corresponding to the particular gesture (e.g., corresponding to the shape of symbol ‘@’) is executed and a corresponding screen appears. That is, when the user performs a gesture on the fog screen in the gesture launch mode, it is detected and an application corresponding to the detected gesture is executed and screen corresponding to the execution of the application is displayed on the display unit 300.

In the embodiment illustrated in FIG. 4, it is assumed that, when the user makes the shape of symbol ‘@’ on the display unit 300, an email writing function is executed and a corresponding screen appears. In that case, the displaying of the fog screen according to a fog event, as shown in diagram 409, may be omitted. That is, the gesture launch mode may be automatically terminated. Automatic termination of the gesture launch mode may be set according to a user's settings, as described above.

Although the embodiment describes a user's gesture corresponding to the shape of the symbol ‘@’ as shown in diagram 407 of FIG. 4, it should be understood that the object 450 according to a user's gesture (corresponding to the shape of the symbol ‘@’) can be displayed in various forms. For example, the object 450 according to a user's gesture (corresponding to the shape of the symbol ‘@’) may be displayed in a paint mode or a transparent mode, as described above. The embodiment of the invention, as shown in diagram 407, is implemented with the transparent mode where a realistic element is shown on the display unit so that the user can easily and intuitively recognize it.

Although the embodiment of FIG. 4 is not described in detail, if no function is mapped to an input gesture, the process of application execution may be omitted. In addition, according to the settings, the embodiment may also be implemented in such a manner that: an error message may be output; a fog screen is initialized by re-inputting an event and then a gesture is re-input; and an error message is output, a fog screen is automatically initialized, and it awaits the re-input of another gesture.

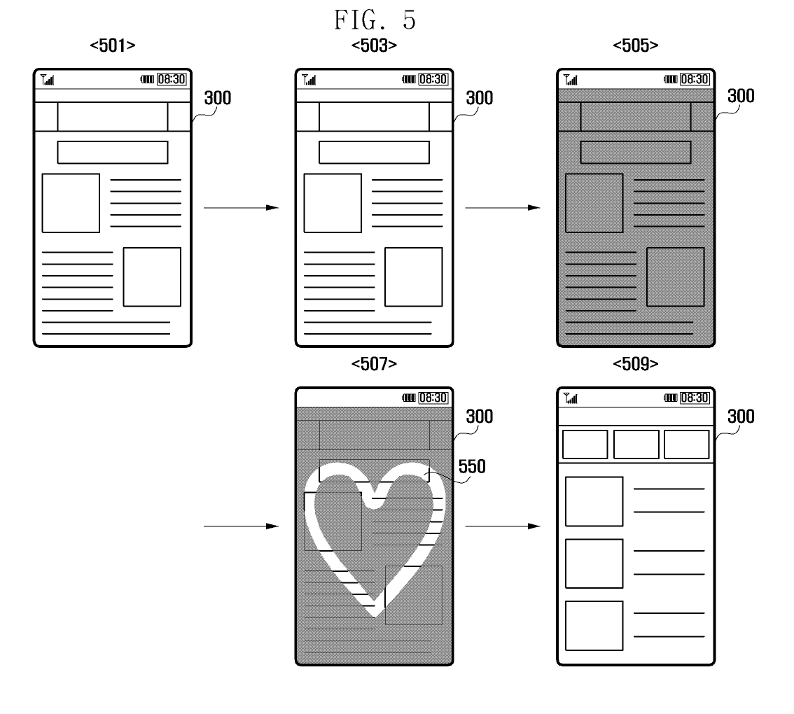

FIG. 5 illustrates another example of screens when a gesture mode is launched in a mobile device, according to an embodiment of the invention. The screens are displayed when a favorite search function is executed by using an input area created by a fog effect, while performing web-browsing.

As shown in diagram 501 of FIG. 5, it is assumed that the mobile device operates a particular application (e.g., an Internet function) and accordingly the display unit 300 displays a screen (e.g., a web-browsing screen). It is also assumed that the event input unit 400 is a microphone or wind sensor and a gesture launch mode is executed when a user blows into the microphone or wind sensor.

A gesture launch mode can be executed in a state where the web-browsing screen is displayed on the display unit 300 as shown in diagram 501. For example, an event for executing a gesture launch mode, such as when a user blows into the device, may occur at the microphone or wind sensor as shown in diagram 503.

When such an event has occurred, a new layer appears on the display unit 300 as shown in diagram 505. In an embodiment of the invention, the new layer may be a translucent layer form having a fog effect so that the user can intuitively or sensibly recognize it. The transparency of the layer is adjustable according to the transparency settings. In an embodiment of the invention, the display unit 300 may provide only a transparent layer form that can allow for the input of a user's gesture-based touch command without a fog effect when the gesture launch mode is executed.

A user's gesture-based input can be applied to the new layer having a fog effect (e.g., a fog screen) in a state where the screen is displayed as shown in diagram 505. For example, a particular gesture (e.g., corresponding to the shape of heart symbol ‘ [symbol] ’) may be performed on the fog screen as shown in diagram 507. In that case, as shown in diagram 509, an application corresponding to the particular gesture (e.g., corresponding to the shape of heart symbol ‘ [symbol] ’) is executed and a corresponding screen appears. That is, when the user performs a gesture on the fog screen in the gesture launch mode, the controller 500 detects the user's gesture. After that, the controller 500 searches for and executes an application that corresponds to the detected gesture and displays a screen corresponding to the execution of the application on the display unit 300.

In the embodiment illustrated in FIG. 5, it is assumed that, when the user makes the shape of heart symbol ‘ [symbol] ’ on the display unit 300, a favorite search function is executed and a corresponding screen appears. In that case, the displaying of the fog screen according to a fog event, as shown in diagram 509, may be omitted. That is, the gesture launch mode may be automatically terminated. Automatic termination of the gesture launch mode may be set according to a user's preferences, as described above.

Although the embodiment describes a user's gesture corresponding to the shape of the heart symbol ‘ [symbol] ’ as shown in diagram 507 of FIG. 5, it should be understood that the object 550 according to a user's gesture (corresponding to the shape of the heart symbol ‘ [symbol] ’) can be displayed in various forms. For example, the object 550 according to a user's gesture (corresponding to the shape of the heart symbol ‘ [symbol] ’) may be displayed in a paint mode or a transparent mode, as described above. The embodiment of the invention, as shown in diagram 507, is implemented with the transparent mode where a realistic element is shown on the display unit so that the user can easily and intuitively recognize it.

Although the embodiment of FIG. 5 is not described in detail, if no function is mapped to an input gesture, the process of application execution may be omitted. In addition, according to the settings, the embodiment may also be implemented in such a manner that: an error message may be output; a fog screen is initialized by re-inputting an event and then another gesture is input; and an error message is output, a fog screen is automatically initialized, and it awaits the input of another gesture.

FIG. 6 illustrates another example of screens when a gesture launch mode is operated in a mobile device, according to an embodiment of the invention. The screens are displayed when a scribbling function is executed by using an input area created by a fog effect.

As shown in diagram 601 of FIG. 6, it is assumed that the display unit 300 is turned off. It is also assumed that the event input unit 400 is a microphone or wind sensor and a gesture launch mode is executed when a user blows into the microphone or wind sensor.

A gesture launch mode can be executed in a state where the display unit 300 is turned off as shown in diagram 601. For example, an event for executing a gesture launch mode, such as a user blowing into the device, may occur at the microphone or wind sensor as shown in diagram 603.

When such an event has occurred, a new layer appears on the display unit 300 as shown in diagram 605. In an embodiment of the invention, the new layer may be a translucent layer form having a fog effect so that the user can intuitively and sensibly recognize it. The transparency of the layer is adjustable according to the transparency settings. In an embodiment of the invention, the display unit 300 may provide only a transparent layer form that can allow for the input of a user's gesture-based touch command without a fog effect when the gesture launch mode is executed.

A user's gesture-based input can be applied to the new layer having a fog effect (e.g., a fog screen) in a state where the screen is displayed as shown in diagram 605. For example, a particular gesture (e.g., a scribbling gesture) may be performed on the fog screen as shown in diagram 607. In that case, as shown in diagram 607, an object according to the user's gesture appears on the display unit 300. Meanwhile, the determination as to whether a gesture is a scribbling gesture is made when the gesture matches a particular form of a predefined gesture, i.e., its information corresponds to information associated with a predefined gesture. When the performed gesture does not match a particular form of a predefined gesture, i.e., the performed gesture's information does not correspond to information associated with a predefined gesture, the mobile device does not execute the applications, as described above in FIGS. 3 to 5, but executes a scribbling function.

An event such as a user blowing on a device may occur at the microphone or wind sensor in a state where the screen is displayed as shown in diagram 607. For example, an event may be re-input in a state where an object appears on the fog screen according to a user's input gestures, as shown in diagram 609. In that case, as shown in diagram 611, a fog screen is initialized by newly applying a fog effect thereto (the fog screen). That is, the objects corresponding to a user's gestures, displayed on the screen as shown in diagrams 607 and 609, are removed when the event occurs, thereby showing a fog screen in an initial state as shown in diagram 611. In addition, when the user performs a gesture on the screen shown in diagram 611, an object corresponding to the gesture appears on the screen as shown in diagram 613. That is, the mobile device can allow the user to perform a writing gesture, a deleting gesture, etc. on the fog screen.

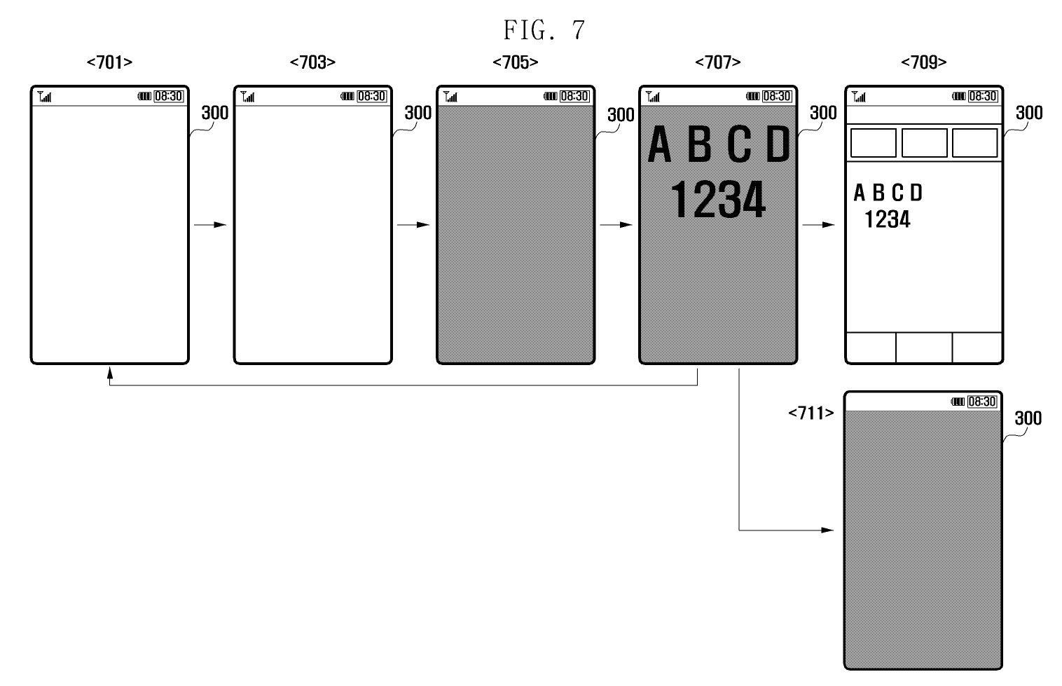

FIG. 7 illustrates another example of screens when a gesture launch mode is operated in a mobile device, according to an embodiment of the invention. The screens are displayed when a note function is executed by using an input area created by a fog effect.

As shown in diagram 701 of FIG. 7, it is assumed that the display unit 300 is turned off. It is also assumed that the event input unit 400 is a microphone or wind sensor and a gesture mode is launched when a user blows into the microphone or wind sensor.

A gesture launch mode can be executed in a state where the display unit 300 is turned off as shown in diagram 701. For example, an event, such as a user blowing into the device, may be detected by the microphone or wind sensor as shown in diagram 703.

When such an event has occurred, a new layer appears on the display unit 300 as shown in diagram 705. In an embodiment of the invention, the new layer may be a translucent layer form having a fog effect so that the user can intuitively and sensibly recognize it. The transparency of the layer is adjustable according to the transparency settings. In an embodiment of the invention, the display unit 300 may provide only a transparent layer form that can allow for the input of a user's gesture-based touch command without a fog effect when the gesture launch mode is executed.

A user's gesture-based input can be applied to the new layer having a fog effect (e.g., a fog screen) in a state where the screen is displayed as shown in diagram 705. For example, the user can successively perform a number of gestures (e.g., shapes of letters and numbers, A, B, C, D, 1, 2, 3, and 4) on the fog screen as shown in diagram 707. In that case, as shown in diagram 709, an application corresponding to a note function is executed and a corresponding screen appears. That is, when the user performs gestures on the fog screen in the gesture launch mode, the controller 500 detects the user's gestures. When a number of gestures are detected, an application corresponding to a note function is executed. The displaying of a screen according to the execution of the note application can also be controlled. When the note application is executed, it converts the objects corresponding to the detected gestures into text and then automatically displays it on the note field on the display unit 300. For example, as shown in diagram 709, the text, A, B, C, D, 1, 2, 3, and 4, can automatically be displayed on the display unit 300 corresponding to the objects as the user makes gestures in the shapes of the letters and numbers A, B, C, D, 1, 2, 3, and 4. Therefore, the user can immediately make a note via the note function and then store it in the mobile device. The displaying of the fog screen according to a fog event, previously performed, as shown in diagram 409 of FIG. 4, may be omitted. That is, the gesture launch mode may be automatically terminated. Automatic termination of the gesture launch mode may be set according to a user's settings, as described above.

As shown in diagram 709, the display unit 300 displays a screen when an application of a note function is executed. On the other hand, when a number of objects corresponding to a user's gestures are input and no further input is created during a preset period of time, the display unit 300 displays a fog screen that is initialized as shown in diagram 711. In that case, the objects corresponding to previously performed gestures are converted into text via the background execution of a note function and then the text is stored. In addition, the display unit 300 may display a fog screen that is initialized and awaits a user's new gesture. Alternatively, the objects are converted into text according to the background execution of a note function and then the text is stored. After that, the gesture launch mode is automatically terminated and then the display unit reverts to the initial state as shown in diagram 701.

Although the embodiment describes a user's gestures corresponding to the shapes of the letters and numbers A, B, C, D, 1, 2, 3, and 4 as shown in diagram 707 of FIG. 7, it should be understood that the objects according to a user's gestures can be displayed in various forms. For example, the objects according to a user's gestures (corresponding to the shapes of the letters and numbers A, B, C, D, 1, 2, 3, and 4) may be displayed in a paint mode or a transparent mode, as described above. The embodiment of the invention, as shown in diagram 707, is implemented with the transparent mode where realistic elements are shown on the display unit so that the user can easily and intuitively recognize them.

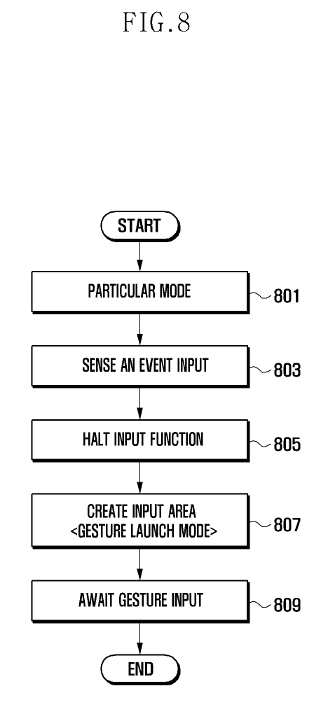

FIG. 8 illustrates a flow chart that describes a method for receiving a user's gesture-based input in a mobile device, according to an embodiment of the invention. In particular, the method refers to a method for creating an input area via a fog effect when an event occurs on the mobile device.

A particular mode is selected by the user or the device (801). Examples of the mode are an idle mode where an idle screen is displayed, an application mode where a screen is displayed according to the execution of a particular application (e.g., an application of a radio broadcasting function, an application of an Internet function, etc.), and a turn-off mode where a display unit is turned off.

After that, a preset input event is received during the particular mode (803). For example, when the user creates an event during the particular mode, the event is sensed and receives an input signal corresponding thereto. In an embodiment of the invention, the event may be a blowing event sensed by a microphone or wind sensor. The event may differ according to the type of event able to be sensed. Examples of the event are a blowing event using a microphone or wind sensor, a pressure event using a pressure sensor, a proximity event using an illumination sensor (or proximity sensor), a motion event using a motion sensor, etc.

After that, a currently executing input function is halted (805). For example, when an event is sensed, the currently displayed screen is retained and halts an input function such as a touch operation.

After that, a new input area is created by operating a gesture launch mode (807). For example, while retaining a given screen, a new layer is created on the screen. In addition, when a gesture mode is launched, it configures the created layer as a fog screen having a fog effect that resembles breath clouding up a glass window.

After operating the gesture launch mode at step 807, another gesture is awaited during the gesture mode (809). After that, the operations according to a user's gestures that are performed via the layer of the fog screen in the gesture mode can be controlled, as described above referring to FIGS. 3 to 7.

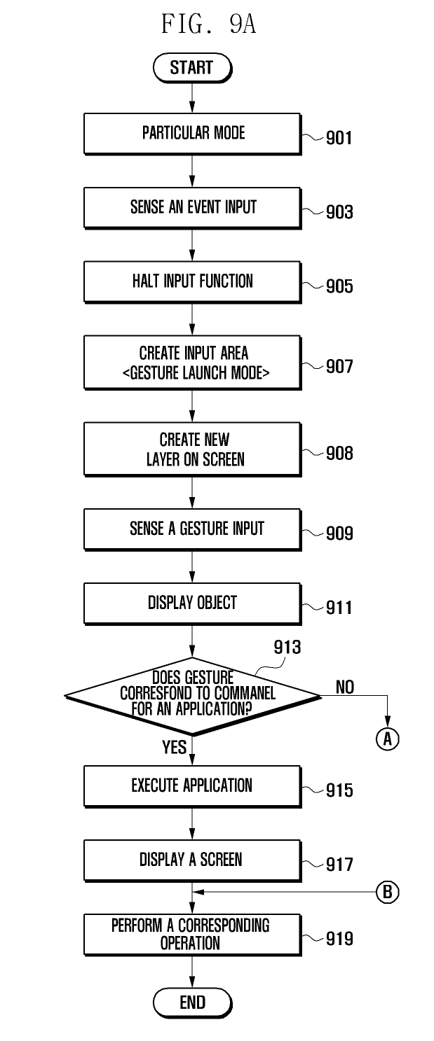

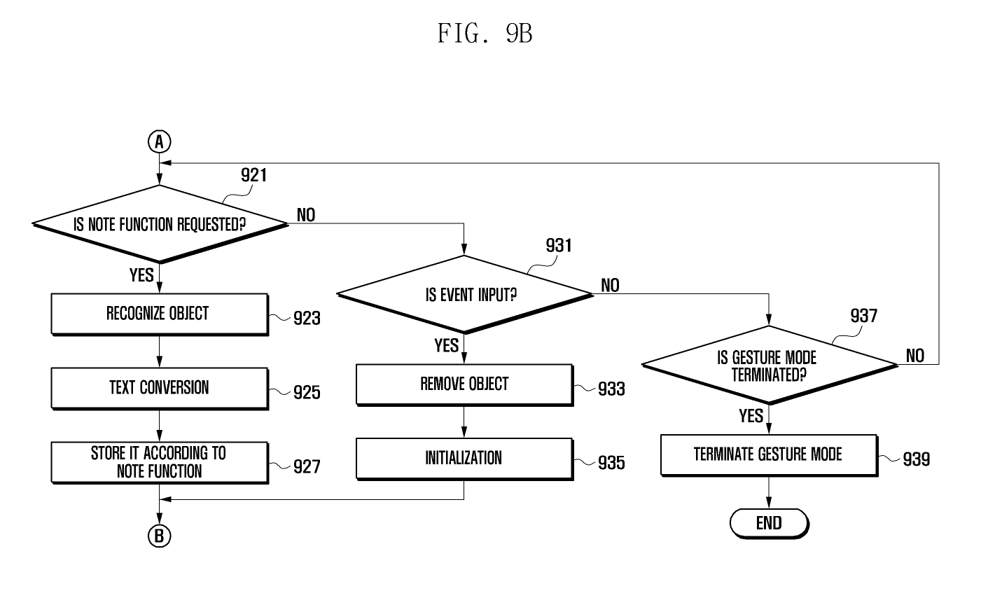

FIGS. 6 and 9B illustrate a flow that describes a method for controlling the execution of a particular function, using an input area created by an event occurred in a mobile device, according to an embodiment of the invention.

The operations for a particular mode are controlled (901). Examples of the mode are an idle mode, an application mode, an off mode, etc., described above.

After that, a preset event is sensed during the particular mode (903). For example, when the user creates an event during the particular mode, the event is sensed and an input signal is received correspondingly. In an embodiment of the invention, the event may be a blowing event sensed by a microphone or wind sensor, a pressure event sensed by a pressure sensor, a proximity event sensed by an illumination sensor or proximity sensor, a motion event sensed by a motion sensor, etc.

After the event input is sensed at step 903, when an input function is halted (905). When data according to an application execution mode is being displayed, a screen that has been displaying data (e.g., an idle screen, an application execution screen, etc.) is retained and an input function is halted with respect to a touch input via an object forming the data (e.g., a linked icon, items such as text, etc.).

After that, a new input area is created by launching a gesture mode after halting the input function (907). While retaining a given screen, a new layer is created on the screen (908). In addition, when a gesture mode is launched, it configures the created layer as a fog screen with a fog effect that resembles breath clouding up a glass window.

A gesture input is sensed via the layer of the fog screen in the gesture mode (909). For example, when the user makes a gesture on the input area, i.e., the creates layer, in a gesture waiting state after executing the gesture launch mode, a corresponding input is sensed and a corresponding input signal is received. As described in the earlier parts referring to FIGS. 3 to 7, the user can launch a gesture mode and perform a gesture on the fog screen provided according to the mode.

The display of the object is controlled corresponding to the user's performed gesture (911). For example, when a gesture performed in the gesture mode is sensed, it controls the display of the shape of the object corresponding to the user's performed gesture (e.g., the shape of the number ‘8’, symbols ‘@,’ and ‘ [symbol] ’ text, etc.), as described in the earlier parts referring to FIGS. 3 to 7.

After that, it is determined whether the performed gesture corresponds to a command for executing an application (913). For example, it is analyzed whether a function can be executed by another gesture performed after displaying an object corresponding to a gesture. That is, it is determined whether the user's performed gesture corresponds to predefined gestures described in table 1. When the user's performed gesture corresponds to one of the predefined gestures, it is concluded that the user's performed gesture is a gesture for executing an application. Alternatively, when the user's performed gesture does not correspond to one of the predefined gestures, it is concluded that the user's performed gesture is an error and may further perform an operation according to the error (e.g., a request for inputting another gesture, etc.).

When it is ascertained that the performed gesture corresponds to a command for executing an application at step 913, it executes an application according to information regarding the user's performed gesture (915). For example, the user's performed gesture is analyzed and it is detected if there exists function information mapped to the performed gesture information. When a gesture is performed, the form of the gesture is identified, function information mapped to the gesture information of the identified gesture is extracted, and an application corresponding to the gesture is executed.

After that, the screen data is displayed according to the execution of the application (917). The operations corresponding to the application executed are performed (919). For example, as describe in the earlier parts, a variety of functions based on the gesture information, such as a shortcut dialing function by a shortcut number, an email writing function, a favorite search function, a note function, etc., can be executed. In an embodiment of the invention, the note function is operated in a manual mode, and this is applied to the description of the method shown in FIGS. 9A and 9B.

On the contrary, according to FIG. 9B, when the performed gesture does not correspond to a command for executing an application at step 913, it is determined whether a note function is requested (921). For example, when an object according to a user's performed gesture is displayed and then the user creates an input to execute a note function an input signal is received corresponding thereto. The note function may be executed by an input signal that is created by performing a preset touch or by operating a preset.

When a note function is requested at step 921, the gesture performed is detected on the layer as an object (923). For example, when a gesture corresponding to the note function is performed, the letter recognition can be performed for objects corresponding to the performed gestures.

After that, the detected objects are converted into text (925). The converted text is stored as note data according to the note function (927).

On the contrary, when a note function is not requested at step 921, it is determined whether an input event occurred (931). For example, when the user creates an event, such as a blowing event, in a state where an object according to a user's performed gesture is displayed, the event is sensed and a corresponding input signal is received.

When an event at step 931 the object is removed (933) and then the input area is initialized (935). For example, the objects are removed via the fog screen of the input area (layer), as described in the earlier part referring to FIG. 6. The fog screen is initialized and then displayed.

On the contrary, when an event does not occur at step 931, it is determined whether an input for terminating a gesture launch mode is created (937). For example, when the user creates an input for terminating a gesture mode in a state where an object corresponding to the user's performed gestured is displayed, a corresponding input signal is received. The gesture mode may be terminated by an input signal that is created by performing a preset touch, creating an event, or operating a particular.

When an input for terminating a gesture launch mode is created at step 937, the gesture mode is terminated (939). When an input for terminating a gesture mode is created, the display of a screen showing given data can be controlled, under the created layer. For example, a layer having a fog effect can be removed and the display of a screen showing data in a particular mode can be shown. On the contrary, when an input for terminating a gesture mode is not created at step 937, it returns to and proceeds with step 921.

As described above, the function providing method and apparatus, according to the invention, can create a fog screen having a fog effect and execute applications according to gestures performed on the fog screen. The function providing method and apparatus can be implemented with program commands that can be conducted via various types of computers and recorded in computer-readable recording media. The computer-readable recording media contain program commands, data files, data structures, or the like, or a combination thereof. The program commands recorded in the recording media may be designed or configured to comply with the invention or may be software well-known to a person of skilled in the art.

The computer-readable recoding media includes hardware systems for storing and conducting program commands. Examples of the hardware systems are magnetic media such as a hard disk, floppy disk, a magnetic tape, optical media such as CD-ROM and DVD, Magneto-Optical Media, such as floptical disk, ROM, RAM, flash memory, etc. The program commands include assembly language or machine code complied by a complier and a higher level language interpreted by an interpreter. The hardware systems may be implemented with at least one software module to comply with the invention.

As described above, the apparatus for receiving a user's gesture-based input and method in a mobile device, according to the invention, can halt an input function with respect to previously input data when an input is created, create a new input area, and process a user's gesture-based function using the input area. The function providing apparatus can be implemented with various types of event input units according to the type of mobile device, for example, a microphone, a wind sensor, an illumination sensor, a proximity sensor, a pressure sensor, a motion sensor, etc. As described above in FIGS. 1-7, an exemplary embodiment of the event input unit 400 are shown on the display unit 300. A person of ordinary skill in the art would recognize that differing location configurations are possible. In addition, the apparatus for receiving a user's gesture-based input and method can create a new input area that can receive a user's gesture-based input when an event occurs, and can provide an optimal environment where a user's gesture can be performed while given data is being displayed. The apparatus for receiving a user's gesture-based input and method can provide a new additional function using an input area that allows a user to perform his/her gestures while another function is being operated. That is, the apparatus for receiving a user's gesture-based input and method can execute the additional function via a simple operation, thereby providing user convenience.

In addition, the apparatus for receiving a user's gesture-based input and method in a mobile device, according to the invention, can halt an input function with respect to previously processed data when a new input area is created, and can operate a user's gesture-based input via the input area created on the layer of data. The apparatus for receiving a user's gesture-based input and method provides the new input area serving as a fog screen having a fog effect, thereby enhancing a user's intuitiveness and sensibility. The apparatus for receiving a user's gesture-based input and method can provide a new input area with a fog effect to a given execution screen, so that the user can intuitively recognize it, and also implements a variety of additional functions based on a user's gestures on the new input area, thereby enhancing use convenience, and competitiveness of the mobile devices.

Although exemplary embodiments of the invention have been described in detail hereinabove, it should be understood that many variations and modifications of the basic inventive concept herein described, which may be apparent to those skilled in the art, will still fall within the spirit and scope of the exemplary embodiments of the invention as defined in the appended claims.

What is claimed is:

1. A method for receiving a user's gesture-based input in a mobile device comprising:
sensing an event that occurs on the mobile device while the mobile device is operating in a particular mode; and
creating a new input area for receiving the user's gesture-based input and displaying the new input area on a display of the mobile device.

2. The method of claim 1, further comprising:
halting, when the event occurs, a currently executing input function with respect to displayed data of the particular mode.

3. The method of claim 2, wherein halting an input function comprises:
launching a gesture mode corresponding to the event input.

4. The method of claim 3, wherein launching a gesture mode comprises:
displaying a fog screen having a fog effect when the gesture mode is launched.

5. The method of claim 4, further comprising:
awaiting a second gesture input; and
controlling, when the second gesture input is sensed, a function corresponding to the second gesture.

6. The method of claim 5, further comprising:
displaying an object corresponding to the second gesture in a transparent or translucent mode.

7. The method of claim 5, wherein the controlling a function comprises:
controlling one of a particular application executing function, a scribbling function, and a note function, according to the second gesture.

8. The method of claim 2, wherein the event comprises one of the following:
a blowing event, a pressure event, a proximity event, and a motion event.

9. A method for receiving a user's gesture-based input in a mobile device comprising:
sensing an event that occurs on the mobile device while the mobile device is operating in a particular mode;
halting a currently executing input function with respect to displayed data of the particular mode;
launching a gesture mode and displaying a fog screen having a fog effect;
receiving the user's gesture via the fog screen; and
controlling a function corresponding to the user's input gesture.

10. The method of claim 9, wherein receiving a user's gesture input comprises:
displaying an object corresponding to the received gesture on the fog screen in a transparent or translucent mode.

11. The method of claim 10, further comprising:
extracting function information mapped to the received gesture; and
controlling the execution of an application according to the extracted function information.

12. The method of claim 10, further comprising:
initializing, when an event occurs, a fog screen on which the object is displayed.

13. The method of claim 10, further comprising:
detecting the object;
converting the detected object into text; and
storing the text in the mobile device.

14. A mobile device for receiving a user's gesture-based input comprising:
an event input unit for receiving an event to launch a gesture mode;
a display unit for displaying, when the gesture mode is executed, a fog screen having a fog effect, and for displaying an object corresponding to the user's gesture-based input to the fog screen in a transparent or translucent mode; and
a controller for halting an currently executing input function when the event input unit receives the event, controlling the displaying of the fog screen according to the launch of the gesture mode, and controlling a function of the mobile device according to the user's gesture-based input performed on the fog screen.

15. The mobile device of claim 14, wherein the event input unit comprises at least one of the following:
a microphone, a wind sensor, a pressure sensor, an illumination sensor, a proximity sensor, and a motion sensor.
